(19) United States
(12) Patent Application Publication
(10) Pub. No.: US 2009/0303276 A1
(43) Pub. Date: Dec. 10, 2009

(54) Collision avoidance measure and sensor

(75) Inventors: Werner Van De Wynckel, Wolvertem (BE); Bart Verhoest, Niel (BE); Bart Verlinden, Tongeren (BE); Konrad Vosteen, Freiburg (DE)

Correspondence Address: AGFA CORPORATION;PATENT DEPARTMENT, 200 BALLARDVALE STREET, WILMINGTON, MA, 01887, US

(73) Assignee: AGFA GRAPHICS NV

(21) Appl. No.: 11/921,265

(22) PCT Filed: May 30, 2006
(86) PCT No.: PCT/EP2006/062686

§ 371 Date: Nov. 29, 2007

Related U.S. Application Data
(60) Provisional application No. 60/690,785, filed on Jun. 15, 2005.

(30) Foreign Application Priority Data
May 30, 2005 (EP) 05104622.5

(51) Int. Cl. B41J 29/393

(52) U.S. Cl. 347/19

(57) ABSTRACT

To avoid possible damaging collisions of a printhead with small receiver defects and other obstacles in a digital printer using a printhead mounted on a scanning shuttle for recording an image on a receiver while scanning along the receiver, a method using the following steps is used:—sensing for possible obstacles having a size smaller and larger than the inkjet head-receiver clearance distance in an area of the receiver to be scanned over by the printhead using a sensor system mounted on the scanning shuttle,—avoiding a collision of the printhead with the obstacle when an obstacle is sensed. Preferably an evaluation step is include to evaluate is a detected obstacle is evaluated to be potentially damaging. A system for using the steps is also disclosed.

### FIELD OF THE INVENTION

The present invention relates to a system for avoiding collisions of a printhead on a scanning shuttle in an inkjet printer. More specifically the invention is related to the detection of small obstacles during printing, with such an inkjet printing apparatus.

### BACKGROUND OF THE INVENTION

### Inkjet Printing

Printing is one of the most popular ways of conveying information to members of the general public. Digital printing using dot matrix printers allows rapid printing of text and graphics stored on computing devices such as personal computers. These printing methods allow rapid conversion of ideas and concepts to printed product at an economic price without time consuming and specialised production of intermediate printing plates such as lithographic plates. The development of digital printing methods has made printing an economic reality for the average person even in the home environment.

Conventional methods of dot matrix printing often involve the use of a printing head, e.g. an ink jet printing head, with a plurality of marking elements, e.g. ink jet nozzles. The marking elements transfer a marking material, e.g. ink or resin, from the printing head to a printing medium, e.g. paper or plastic. The printing may be monochrome, e.g. black, or multi-coloured, e.g. full colour printing using a CMY (cyan, magenta, yellow, black=a process black made up of a combination of C, M, Y), a CMYK (cyan, magenta, yellow, black), or a specialised colour scheme, (e.g. CMYK plus one or more additional spot or specialised colours). To print a printing medium such as paper or plastic, the marking elements are used or “fired” in a specific order while the printing medium is moved relative to the printing head. Each time a marking element is fired, marking material, e.g. ink, is transferred to the printing medium by a method depending on the printing technology used. Typically, in one form of printer, the head will be moved relative to the printing medium to produce a so-called raster line which extends in a first direction, e.g. across a page. The first direction is sometimes called the “fast scan” direction. A raster line comprises a series of dots delivered onto the printing medium by the marking elements of the printing head. The printing medium is moved, usually intermittently, in a second direction perpendicular to the first direction. The second direction is often called the slow scan direction.

The combination of printing raster lines and moving the printing medium relative to the printing head results in a series of parallel raster lines, which are usually closely spaced. Seen from a distance, the human eye perceives a complete image and does not resolve the image into individual dots provided these dots are close enough together. Closely spaced dots of different colours are not distinguishable individually but give the impression of colours determined by the amount or intensity of the three colours cyan, magenta and yellow which have been applied.

In order to improve the veracity of printing, e.g. of a straight line, it is preferred if the distance between dots of the dot matrix is small, that is the printing has a high resolution. Although it cannot be said that high resolution always means good printing, it is true that a minimum resolution is necessary for high quality printing. A small dot spacing in the slow scan direction means a small distance between marker elements on the head, whereas regularly spaced dots at a small distance in the fast scan direction places constraints on the quality of the drives used to move the printing head relative to the printing medium in the fast scan direction.

Generally, there is a mechanism for positioning a marker element in a proper location over the printing medium before it is fired. Usually, such a drive mechanism is controlled by a microprocessor, a programmable digital device such as a PAL, a PLA, an FPGA or similar although the skilled person will appreciate that anything controlled by software can also be controlled by dedicated hardware and that software is only one implementation strategy.

Most numbers of such prints are produced in the home and office environment using small apparatus capable of printing on relative small areas only. Most popular paper formats are standard office formats such as the ISO 216 A4 paper size and the ANSI/ASME Y14.1 Letter format. Larger size printers usually can print on ISO 216 A3 or ANSI/ASME Y14.1 Tabloid format.

In all, these printers are limited in size and throughput.

In recent times e.g. inkjet printers have evolved to more industrial applications. A lot of these printers can handle larger paper formats or use special types of ink.

To improve the clarity and contrast of the printed image, recent research has been focused to improvement of the used inks. To provide quicker, more waterfast printing with darker blacks and more vivid colours, pigment based inks have been developed. These pigment-based inks have a higher solid content than the earlier dye-based inks. Both types of ink dry quickly, which allows inkjet printing mechanisms to forms high quality images. In some industrial applications, such as making of printing plates using ink-jet processes inks having special characteristics causing specific problems. E.g. UV curable inks exist to allow rapid hardening of inks after printing. An example can be found in WO 02/53383.A special UV source has then to be provided for curing the inks after printing. After the ink of a printed band has been partially cured by the UV source, the band can be immediately be overprinted without the problem that the ink drops will mix causing artefacts.

Using this ink allows for the use of high quality printing methods at a high speed avoiding several other problems inherent to the nature of the recording method.

One general problem of dot matrix printing is the formation of artefacts caused by the digital nature of the image representation and the use of equally spaced dots. Certain artefacts such as Moiré patterns may be generated due to the fact that the printing attempts to portray a continuous image by a matrix or pattern of (almost) equally spaced dots. Another source of artefacts can be errors in the placing of dots caused by a variety of manufacturing defects such as the location of the marker elements in the head or systematic errors in the movement of the printing head relative to the printing medium. In particular, if one marking element is misplaced or its firing direction deviates from the intended direction, the resulting printing will show a defect which can run throughout the length of the print. A variation in drop velocity will also cause artefacts when the printing head is moving as time of flight of the drop will vary with variation in the velocity. Similarly, a systematic error in the way the printing medium is moved relative to the printing medium may result in defects, which may be visible. For example, slip between the drive for the printing medium and the printing medium itself will introduce errors. In fact, any geometrical limitation of the printing system can be a source of errors, e.g. the length of the printing head, the spacing between marking elements, the indexing distance of the printing medium relative to the head in the slow scan direction. Such errors may result in “banding” that is the distinct impression that the printing has been applied in a series of bands. The errors involved can be very small—the colour discrimination, resolution and pattern recognition of the human eye are so well developed that it takes remarkably little for errors to become visible.

To alleviate some of these errors it is known to alternate or vary the use of marker elements so as to spread errors throughout the printing so that at least some systematic errors will then be disguised. For example, one method often called “shingling” is known from U.S. Pat. No. 4,967,203 which describes an ink jet printer and method. Each printing location or “pixel” can be printed by four dots, one each for cyan, magenta, yellow and black. Adjacent pixels on a raster line are not printed by the same nozzle in the printing head. Instead, every other pixel is printed using the same nozzle. In the known system the pixels are printed in a checkerboard pattern, that is, as the head traverses in the fast scan direction a nozzle is able to print at only every other pixel location. Thus, any nozzle which prints consistently in error does not result in a line of pixels in the slow scan direction each of which has the same error. However the result is that only 50% of the nozzles in the head can print at any one time. In fact, in practice, each nozzle prints at a location which deviates a certain amount from the correct position for this nozzle. The use of shingling can distribute these errors through the printing. It is generally accepted that shingling is an inefficient method of printing as not all the nozzles are used continuously and several passes are necessary.

Another method of printing is known as “interlacing”, e.g. as described in U.S. Pat. No. 4,198,642. The purpose of this type of printing is to increase the resolution of the printing device. That is, although the spacing between nozzles on the printing head along the slow scan direction is a certain distance X, the distance between printed dots in the slow scan direction is less than this distance. The relative movement between the printing medium and the printing head is indexed by a distance given by the distance X divided by an integer. More sophisticated printing schemes can be found in e.g. European application EP 01000586 and U.S. Pat. No. 6,679,583.

Another problem is that high acceleration values are needed when the shuttle starts printing. Acceleration can be up to 10 m/s² Lower acceleration values to reach high printing speeds would give less problems regarding vibrations but would lead to loss of time due to longer run-up time and inevitably longer run-up distance leading to even larger dimensions of the overall apparatus giving rise to more problems of stability. Preferably these industrial printers are capable of printing on large paper sized and obtain a high throughput. Sizes up to 200—280 cm are desirable as output format. Special applications are e.g. poster printing, advertising. To obtain a higher throughput usually several printheads are used at the same time.

Thus these industrial printers usually comprise:
large size recording units
use of multiple heads
heavier weight
high speed movements over long distances
higher accelerations
complicate recording schemes (shingling, interlacing,)
large ink reservoirs with online replenishment of the ink tanks on the printhead shuttle.
   and can further also comprise:
UV pre-curing installation
cooling means
cabling and ink transport tubes.

Small office printers using up to a standard A3 paper size usually use a platen roller for holding the receiver while the printhead scans the receiver at a close distance. An important aspect is that the industrial printers use large size receivers and large size printheads to efficiently record images on the receiver. Due to the larger size it is not possible to use a platen roller as these rollers can only provide a very limited flat area and the large size printhead need at least a flat area corresponding to the length of the head. Printing on a curved section of a platen roller would result in de difference in throw-distance of the jetted drops along the printhead resulting in misplace drops a distortion of the image. Therefore in industrial printers the receiver table is usually flat and the receiver is usually
roll fed and is moved, sometimes intermittently over the receiver table, or,
sheet fed wherein the sheet is slowly fed-through or held statically on a receiver table; usually held by a vacuum.
   The receiver is usually paper by all other sort of receiving media are possible, e.g. vinyl, mesh media, etc. Some problems occur when using these media.

Roll fed media may contain splices having a greater thickness than the normal media. Uneven tensioning of the roll media may occur developing folds in the normally flat feed path Sheet feed and roll media may have defects, impurities or e.g. small tears due to previous handling or printing processes. Sheet fed material typically may develop dog-ears due to careless handling. Another important cause of unevenness or wrinkles is the fact that the receiver may contract or expand when held on the receiver table. This may occur e.g. due to thermal effects when the receiver stock is not stored at working temperature or due to the deformation of the receiver as a result of the ink already deposited on the material which may cause swelling of the material. These defects occur during printing and can not be always detected in advance during loading of the receiver. Especially when using large size receiver materials as used industrial inkjet printers this problem may occur.

In all printing systems either the receiver moves along the printhead or the printhead scans along e.g. the paper width to record the image. The apparatus is normally designed to ensure that the printhead moves along the receiver at very close distance to ensure high quality printing.

These receiver defects may become larger than the clearance between the top side of the receiver and the inkjet printhead. Also small objects may be accidentally left on the receiver.

Due to the close recording distance the printheads and especially the writing ends, such as the nozzle plates may come into contact with the defects present on or in the receiver. Due to the higher speed and high weight of the shuttles (e.g. 50 up to 400 Kg) in industrial printers, and the type of recording material this may lead to situations that result in damage to the printhead, dislocation of certain accurately positioned recording elements as sometime large portions of the receiver are crumpled and pulled between receiver table and recording head. This results in expensive replacements, readjustments and loss of production time.

These damaging collisions or abrasive shearing contacts of the receiver with the recording heads have to be avoided or the risk of damage due to collisions has to be diminished when one wants avoid costs and safeguard the good working of the printing apparatus. Manual inspection systems are far too tedious and too expensive as a machine operator has to be present all the time, Some prior art documents address problems which are remotely related to the problem to be solved by the present invention: In US 2003/197750 a textile printer is equipped with an obstacle detection system before the receiver is transported into the printing zone which is covered by the shuttling printhead. US 2002/190191 discloses a mechanical safety device to avoid collisions with the operator or obstacles on the processing table. EP 458 098 describes a electromechanical device for detecting sideway collisions. EP 785 070 is also directed to operator safety where a mechanical system detects large obstacle before the medium is in the printing zone. In US 2004/165018 collisions are detected afterwards as a restriction in movement has taken place. This means damage is already present. This system is only usable in small office and home printers having lightweight shuttles and low power drive systems.

All prior art systems may be capable to detect obstacles much larger than the receiver-printhead clearance causing collisions or are only capable of detecting obstacles before the receiving medium reaches the printing zone.

It is clear that the state of the art printers do not provide a solution to the problem of possible damage by emerging obstacles and paper defects during printing in the printing zone as can be present in large size industrial printers.

### SUMMARY OF THE INVENTION

The above-mentioned advantageous effects are realised by a method having the specific features set out in claim 1. Specific features for preferred embodiments of the invention are set out in the dependent claims. Systems for using the method are claimed in claim 7 and dependent claims

Further advantages and embodiments of the present invention will become apparent from the following description and drawings.

### BRIEF DESCRIPTION OF THE DRAWINGS

FIG. 1 depicts a possible embodiment in a printer wherein a receiver moves along a page-wide printhead.

FIG. 2 shows a printing geometry wherein a stepwise fed receiver sheet is scanned by a shuttling printhead.

FIG. 3 shows a printing geometry wherein a printhead shuttle comprising a printhead scans a receiver.

FIG. 4 illustrates the relative position of the sensor and laser light source relative to the receiver.

### DETAILED DESCRIPTION OF THE INVENTION

The present invention provides an automated method for avoiding printhead collisions in a digital printer wherein a printhead, mounted on a scanning shuttle, is used for recording an image on a receiver during a relative scanning movement of the printhead along the receiver comprising the following steps:
sensing for possible obstacles in an area of the receiver to be scanned over by the printhead and
avoiding a collision of the printhead with the obstacle when an obstacle is sensed, wherein the obstacle sensor is mounted on the shuttle and is detecting obstacles having a size smaller than the inkjet-receiver clearance distance.

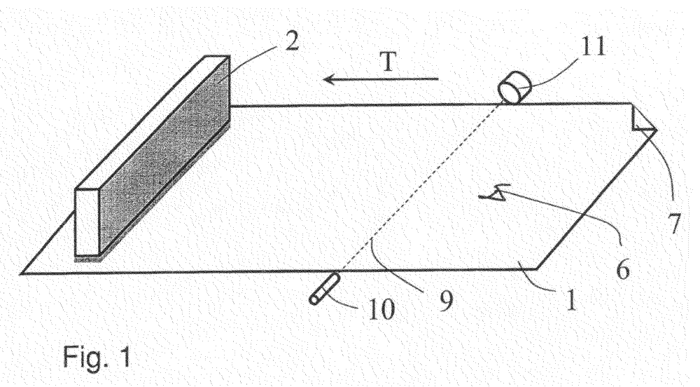

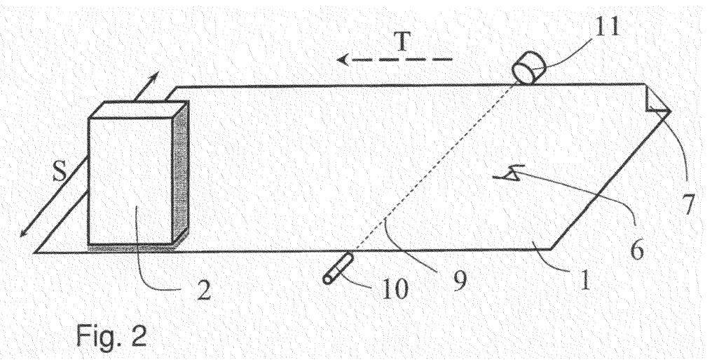

Referring to FIGS. 1 to 2 it can be seen that in prior art configurations a sensing method can be used in printers wherein a receiving medium 1 in the form of a sheet, plate or a web is transported along a path thereby passing at least one printhead 2 which records the image on the receiver 1 and wherein the sensing system is fixed The printhead 2 in this case can be
a stationary page-wide printhead 2 as in FIG. 1 of which the length is normally about the width of the receiver 1 at right angle to the transport direction T. This page width printhead 2 may be composed of several sub-head which are combined to form a large size head.
The printhead 2 can also be of a shuttling type as in FIG. 2.
   The receiver 1 is usually transported in steps in a transport direction T and a printhead shuttles the transverse shuttle direction S in between the transport steps. In this case there is a relative movement alternating in the two directions, i.e. transport direction T and shuttling direction S.

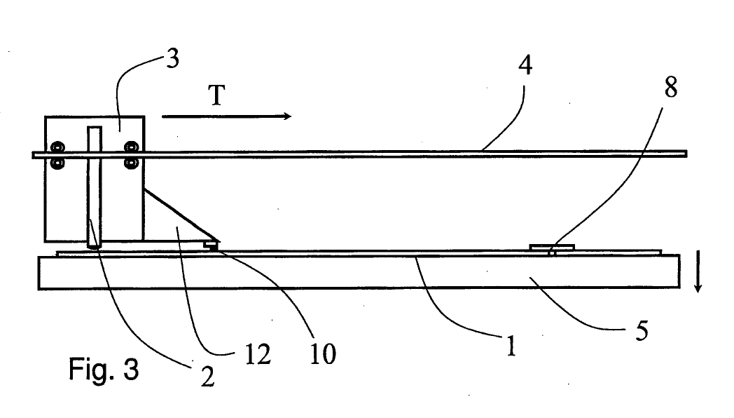

The present invention relates to printer constructions as shown in FIG. 3 wherein the receiver 1 is held stationary and the printhead 2, normally mounted in a shuttle 3 running over guide rails 4, will shuttle repeatedly over the receiver on a receiver table 5 and during the scanning movement will record the image on the receiver 1. The printhead 2 can be of a page-wide type but needs to scan the receiver repeatedly due to interlacing and shingling requirements.

The printheads 2 used may be of any type, e.g. using recording method needing using impact or contact printing e.g. stylus or thermal recording or usually using non-impact systems such as toner-jet or much more popular inkjet recording methods.

### Obstacle Detection

The first step in order to avoid collisions is that an obstacle has to be detected.

The detector has to be in accordance with the kind of obstacle which is to be expected in the application in which the printer is used. Several kind of obstacles are possible, some examples are
tears of the recording medium 6
folds and creases
dog ears. 7
foreign particles left on the receiver or present under the receiver on the receiver table thereby lifting the receiver.
splices 8 present in roll fed media or sheet media.
   But the present invention is especially directed to defects possible arising in the printing zone during printing due to e.g. wetting of the paper as printing is done, deformations due to thermal effects acting upon the large sheets in industrial processes. etc.

Several detector types can be used: The first type are based on systems using light:

It is possible to use camera systems taking pictures or video images of the part of the receiver 1 which have to be scanned by the printhead or which still have to pass the stationary printhead 2 during further printing.

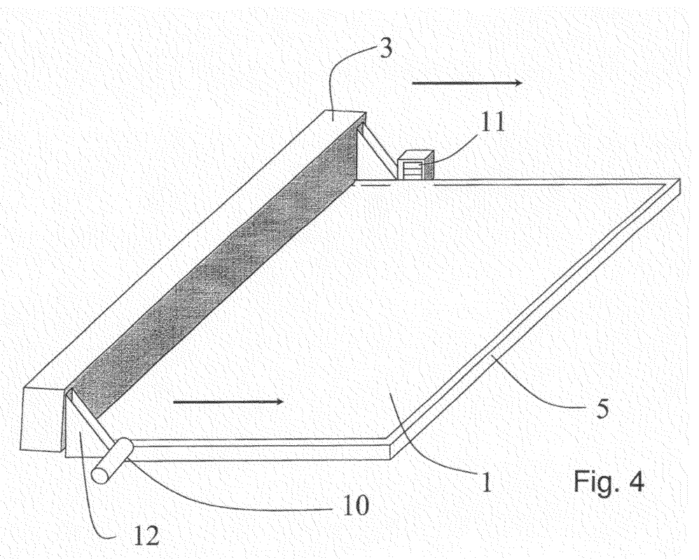

Based upon these images it is possible, using e.g. image processing software to detect obstacles. The performance of these systems can be greatly enhanced using special lighting, e.g. oblique lighting of the area using special patterns, greatly enhancing the visibility and detection threshold of variations in topography of the receiver 1. As illustrated in FIG. 4 other systems, more simple, using visual light may include e.g. a single light beam from a semiconductor laser 10, spanning the receiver very close to the area to be guarded and which is detected by one or more photoelectric cells 11. The spacing of the light beam to the receiver is less or at least equal to the spacing between printhead 2 and receiver 1.

More elaborate systems can use e.g. scanning light beams passing over or through the receiver 1. Especially when using a transparent receiver a scanning light beam can be used which is detected at the other side of the receiver by an elongated photoelectric cell 11. Any variations in optical density may point out obstacles on the receiver 1.

Instead of a single beam several beams along or/and above each other may be used or a small sheet-like laser bundle could be used. This can provide more information on the size or height of an obstacle on the receiver 1 or the folds in the receiver 1. To enhance the visibility of certain materials or problems which may be expected a preferred wavelength of the light can be used. When e.g. fluorescent foreign particles can be expected, it can be advantageous to use UV light to detect these objects. And even the colour of an obstacle could be detected.

Systems may be used which can detect unevenness using ultra-sound detection and even X-ray methods can be used to detect problems in e.g. a web.

The photoelectric cells used can be a single cell photoelectric cell 11 or could be a segmented sensor as used in U.S. Pat. No. 4,626,673. Leaving possibility to obtain more info over the detected object or problem. Detection can even be done using CCD or camera systems enabling an even more detailed examination of the measured light intensities.

As mentioned above an elongated photoelectric cell 11 can be used or several small cells can form a elongated detector.

The aim is to obtain sufficient info over obstacles which could lead to a potentially damaging collision with the printhead 2.

The main aim of the present invention is to be able to detect small obstacles which may emerge during printing but can be damaging to the printheads passing over the material. To be able to detect such a small obstacle special arrangements can be made. As illustrated in FIG. 4, the detection system comprising a light source, e.g. a semiconductor laser and several photoelectric cells preferable situated aside the edge of the printing table, thus allowing detection of very small obstacles. In the depicted example no details are given but an alignment system of the laser and detectors is preferable. The detector system must also be able to distinct the laser light from ambient light or light used for the imaging process. This is certainly the case if e.g. UV curable inks are used which need UV light to harden the jetted ink in a inkjet system. Certain colour filters may help to distinguish between light from the detection system and ambient or other types of light used in the printer.

Also a system can be provided for regulating the height of the sensor system above the receiver as the thickness of the receiver may vary from one print job to another.

When detecting any fault in the flatness of the receiver 1 it is possible to take immediate action to avoid the collision, but preferably the info on the detected obstacle is evaluated during an evaluation step wherein it is evaluated if the detected obstacle is considered to be potentially damaging to the printhead 2 and wherein it is decided that an avoidance step is taken when the obstacle is evaluated to be potentially damaging to the printhead 2.

The evaluation can be based upon the size, height, or colour of the object, but even more complicated evaluations can be made when using a video camera system. Even the form or outline of an obstacle can then be determined which could give information about the nature of the obstacle.

Upon detection of an obstacle, or when an evaluation step is included upon evaluation that an obstacle is potentially damaging, an avoidance step is taken to avoid the collision.

Avoidance of collision is normally done by aborting the relative scanning movement of the printhead 2 over the receiver 1. This can, dependent upon the printer architecture be done by halting the shuttling printhead 2 or stopping the feeding of the receiver 1. When sensing is done before printing starts, the printing movement can be prevented to start.

Other collision avoidance actions can be used. If the printhead 2 is retractable it is possible to retract the printhead 2 from the vicinity of the receiver 1 by retracting the printhead 2 in the shuttle 3 or it is possible to lower the receiver table 5 rapidly thus removing the printhead 2 from along the receiver 1 on the receiver table 5, i.e. to enlarge the receiver-printhead distance. It is understood that a combination of all these methods can be used during the avoidance step.

Another method of avoidance, of which the application can make use is to try to remove any foreign object, e.g. after stopping or preventing the scanning motion by use of e.g. pressurised air blowing over the receiver 1 and directed to the foreign object or by use of a brush type tool running over the receiver 1 or by intervention of the operator which is adverted by the detection mechanism.

Other steps which may be taken after detection of a obstacle is
removal of the receiver 1 after the printing is halted or prevented.
   When printing on roll fed media, it is important that the position of the section of the roll having the defect is stored in a log file and. eventually marked on the roll so that this section can be found or skipped during later treatment of handling of the media roll. When the roll medium is cut after printing the defective area can be cut-out and can be removed from the work flow.

Detection of objects and potential damaging collision conditions may give also rise to several routines including fully automated recovery routines or routines involving operator supervision or intervention.

As mentioned above it is possible to perform the detection step even before any printing is done. This provides that detected obstacles can be removed or folds, dog-ears can be corrected so that loss of recording media can be avoided. This however takes more time as printing has to be halted until the receiving medium 1 is detected and evaluated to be safe before printing is started.

Normally the sensing step is done during the printing step but carried out at an appropriate distance before the area which will be printed by the printhead 2.

The potential collision avoidance is carried out using dedicated system for avoiding potential collision conditions comprising:
an obstacle sensor for detecting obstacles in the receiver area to be scanned by the printhead,
a collision avoidance device for taking action to avoid a collision when an obstacle is detected by the obstacle sensor.

An extra evaluation device can be used to evaluate that the obstacle detected is potentially damaging to the printhead 2. This can be a simple logic circuit but complicated image processing devices may be included. These can include analog processing devices or digital image or signal processing devices.

The collision avoidance devices is preferably for preventing or halting the relative scanning movement of the printhead 2 over the receiver 1.

When the printhead 2 is retractable from along the receiver 1 on a receiver table 5 and the collision avoidance device is for retracting the printhead 2 from the vicinity of the receiver 1 or lowering the receiver table 5 upon detection of an obstacle. As the obstacle sensor is mounted upon the shuttle 3 as in FIG. 3 and 4, it is possible to retract only the printhead or to retract the whole shuttle including the obstacle sensor.

Obstacle sensing can also be done using the shuttle while the printheads are in a retracted position.

When object detection is done during printing the distance between sensor and printing head 2 has to be sufficient to allow timely take the collision avoidance action by e.g. halting of the scanning movement. As illustrated in FIG. 3 this can be e.g. a special mounting device 14 attached to the printhead shuttle 3 running along the guide rails 4.

Having described in detail preferred embodiments of the current invention, it will now be apparent to those skilled in the art that numerous modifications can be made therein without departing from the scope of the invention as defined in the appending claims.

1. A method for automatically avoiding printhead collisions in a digital printer using a printhead mounted on a scanning shuttle, for recording an image on a receiver while there is a relative scanning movement of the printhead along the receiver, the method comprising the steps of:
sensing for an obstacle in an area of the receiver to be scanned by the printhead; and
avoiding a collision of the printhead with the obstacle when the obstacle is sensed,
characterised in that the sensing step senses the obstacle in a printing zone by use of a sensing system mounted on the scanning shuttle.

2. A method according to claim 1 wherein the sensing step is done during printing.

3. A method according to claim 1 wherein the sensing step is done before printing is started.

4. A method according to claim 1 further comprising the step of evaluating upon detection if the detected obstacle is considered to be damaging to the printhead and wherein the avoidance step is taken when the obstacle is evaluated to be damaging to the printhead.

5. A method according to claim 1 wherein the step of avoiding a collision includes preventing or aborting the scanning movement.

6. A method according to claim 1 wherein the step of avoiding a collision includes retracting the printhead away from a vicinity of the receiver or retracting the receiver from the printhead.

7. System for automatically avoiding potential collision conditions in a digital printer for recording an image on a receiver having a printhead mounted on a scanning shuttle, for recording the image on the receiver during a scanning action providing relative movement of the printhead over the receiver, the system comprising:
an obstacle sensor for detecting an obstacle in a receiver area to be scanned by the printhead; and
a collision avoidance device for taking action to avoid a collision when the obstacle is detected by the obstacle sensor,
characterised in that the sensor is mounted on the scanning shuttle and senses the obstacle in a printing zone.

8. The system according to claim 7 further comprising an evaluation device for evaluating that the detected obstacle is damaging to the printhead, and the collision avoidance device is for taking action to avoid the collision only when the obstacle is evaluated as damaging to the printhead.

9. The system according to claim 7 wherein the collision avoidance device is for preventing or halting the relative scanning movement of the printhead over the receiver.

10. The system according to claim 7 wherein the printhead is retractable from along the receiver on a receiver table and the collision avoidance device is for retracting the printhead from a vicinity of the receiver or lowering the receiver table upon detection of the obstacle.
